(19) United States
(12) Patent Application Publication
(10) Pub. No.: US 2004/0243399 A1
(43) Pub. Date: Dec. 2, 2004

(54) Computer system and method of controlling the same

(75) Inventor: Ho-jin Ha, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-si (KR)

(21) Appl. No.: 10/820,821

(22) Filed: Apr. 9, 2004

(30) Foreign Application Priority Data
Jun. 2, 2003 (KR) 2003-35332

(51) Int. Cl. G10L 19/00

(52) U.S. Cl. 704/201

(57) ABSTRACT

A computer system with a microphone inputting a voice (sound) signal and a storage storing data. The system also has a selection part selecting a voice signal recording, a signal processing part processing the voice signal input through the microphone, and a recording control part managing the input voice signal to be processed by the signal processing part and storing the processed voice data in the storage unit. Upon activation of the voice recording selection part when the system is turned off, a power supply part is activated to supply powers only to sound recording system components, for example, the microphone, the storage unit, the signal processing part, and the recording control part. The computer system provides a computer system allowing recording voice signals regardless of whether the system boots up.

### CROSS-REFERENCE TO RELATED APPLICATIONS

This application claims the benefit of Korean Patent Application No. 2003-35332, filed Jun. 2, 2003, in the Korean Intellectual Property Office, the disclosure of which is incorporated herein by reference.

### BACKGROUND OF THE INVENTION

1. Field of the Invention

The present invention relates to a computer system and a method of controlling the computer system, and more particularly, to a computer system and a method of controlling the computer system by recording voice signals without regard to whether the computer system boots up.

2. Description of the Related Art

A portable cassette tape recorder or a portable tape-less (e.g., digital) voice recorder is usually used for recording voice signals. The compact size and a long recording time of the tape-less voice recorder is advantageous over the cassette tape recorder and has widely grabbed consumers' attention. A typical tape-less voice recorder saves contents of conferences or meetings in a memory chip using a microphone, and can be controlled to promptly replay the voice-recorded contents through a speaker later.

Such tape-less voice recorders are portable and available for instant recording with easiness of one-touch operation, but have a limited recording time due to a storage capacity of the memory chip. Meanwhile, a computer system can provide a sound recording software to record voice signals, and has an advantage of a longer recording time with a hard disk storage capacity of the computer system. However, the sound recording software requires a user to use a mouse and a keyboard, if the user wants to use the software, and is available only after the computer boots up, thereby posing a problem for recording promptly due to the booting time.

### SUMMARY OF THE INVENTION

Accordingly, the present invention provides a computer system and an easy method of recording voice signals by the computer system regardless of whether the system boots up.

Additional aspects and/or advantages of the invention will be set forth in part in the description which follows and, in part, will be obvious from the description, or may be learned by practice of the invention.

The foregoing and/or other aspects of the present invention may be achieved by providing a computer system having a microphone inputting a voice signal and a storage unit storing data, and the system further comprising a selection part selecting a voice signal recording control in a signal processing part processing the voice signal input through the microphone, a recording control part managing the input voice signal to be processed by the signal processing part in response to the selection of the voice signal recording control in the selection part and saving a processed voice data in the storage unit, and a power supply part supplying power to the voice recording system components, including the microphone, the storage unit, the signal processing part, and the recording control part, when the selection part selects the voice signal recording control without the power being supplied to the computer system (i.e., selecting the voice signal recording control when the computer system is off).

According to an aspect of the invention, the computer system further comprises an interrupt generating part generating an interrupt signal in response to the selection in the selection part, and wherein the recording control part comprises an interrupt processing routine processing the interrupt signal from the interrupt generating part, and processing a voice recording program called by the interrupt processing routine.

According to an aspect of the invention, the interrupt processing routine of the computer system is disposed in a BIOS ROM, and the voice recording program is disposed in either the BIOS ROM or the storage unit.

According to an aspect of the invention, the interrupt processing routine in the BIOS ROM calls the voice recording program to be executed in response to the selection in the selection part when power is not being supplied to the computer system.

According to an aspect of the invention, the voice recording program executes under a DOS application.

According to an aspect of the invention, the computer system further comprises a pre-determined driver including the interrupt processing routine based on an operation system, and the driver calls the voice recording program to be executed in response to the selection in the selection part after the computer system boots up.

According to an aspect of the invention, the voice recording program is a RAM-resident program based on the operating system.

According to an aspect of the invention, the voice recording program further comprises a user interface for a user to select replaying voice data saved in the storage unit, and wherein the voice recording program reads the voice data saved in the storage unit, if replaying is selected through the user interface and allows the signal processing part to process the voice data, thereby outputting the processed data through a speaker.

The present invention may also be achieved by a method of controlling a computer system having a microphone inputting a voice signal and a storage unit storing data, the method comprising selecting a voice signal to be recorded; processing the input voice signal through the microphone according to the void signal recording selection; saving the processed voice data in the storage unit; and supplying power to components for voice recording, including the microphone and the storage unit, when voice recording is selected without power being supplied to the computer system.

According to an aspect of the invention, the method of controlling the computer system further comprises generating an interrupt signal responding to the voice signal recording selection, and calling a voice recording program to be executed.

According to an aspect of the invention, in the method of controlling the computer system, the calling of the voice recording program by the interrupt signal is enabled by a BIOS program and the voice recording program is disposed in either a BIOS ROM or the storage unit.

According to an aspect of the invention, the method of controlling the computer system further comprises calling by the BIOS program the voice recording program to be executed, in response to the voice signal recording selection when the power is not being supplied to the computer system.

According to an aspect of the invention, in the method of controlling the computer system, the voice recording program is a DOS-based application.

According to an aspect of the invention, in the method of controlling the computer system, the calling of the voice recording program by the interrupt signal is enabled by a pre-determined driver based on an operating system; and the method further comprising calling by the driver the voice recording program to be executed in response to the voice recording selection after the computer system boots up.

According to an aspect of the invention, in the method of controlling the computer system, the voice recording program is a RAM-resident program based on the operating system.

According to an aspect of the invention, the method of controlling the computer system further comprises selecting replay of the voice data saved in the storage unit, reading the voice data saved in the storage unit to be processed in signals, and outputting the processed voice data through the speaker in response to the replay selection.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a perspective view of a computer system, according to an embodiment of the present invention;

FIG. 2 is a functional control block diagram of the computer system of FIG. 1, according to an embodiment of the present invention;

FIG. 3 is a functional control block diagram of voice recording before booting up in the computer system of FIG. 2;

FIG. 4 is a functional control block diagram of voice recording after booting up in the computer system of FIG. 2; FIG. 5 is a flowchart of the voice recording before the computer system boot, according to FIG. 3;

FIG. 6 is a flowchart of the voice recording after the computer system boot, according to FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

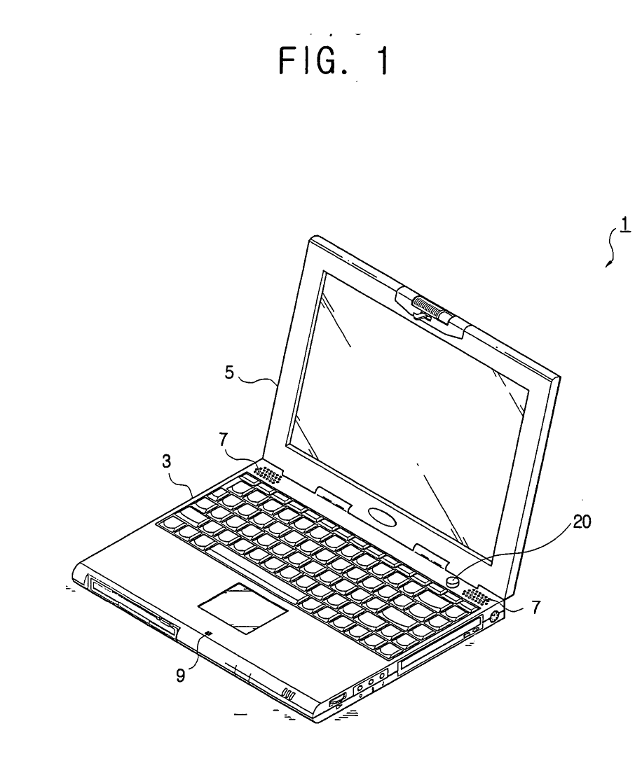

FIG. 1 is perspective view of a computer system 1, according to an embodiment of the present invention. The computer system 1, for example, a portable computer 1, has a main body 3 in which various hardware modules are installed, and a display panel 5 displaying an image signal from the main body 3. The main body 3 of the portable computer 1 has a speaker(s) 7, a microphone 9, and a selection part 20 to select (control) a voice recording (i.e., a selection part 20 to input a selection of sound recording). As shown in FIG. 1, the selection part 20 may be any hardware manipulation part, such as a switch, a button, etc., providing a sound recording selection switch.

The speaker 7 is an output device outputting sounds like an alarm sound, or replaying audio data. The speaker 7 emits sounds if a user wants to play audio files, audio CDs, or recorded voice data through the main body 3 of the computer system. The microphone 9 receives voice signals input by the user.

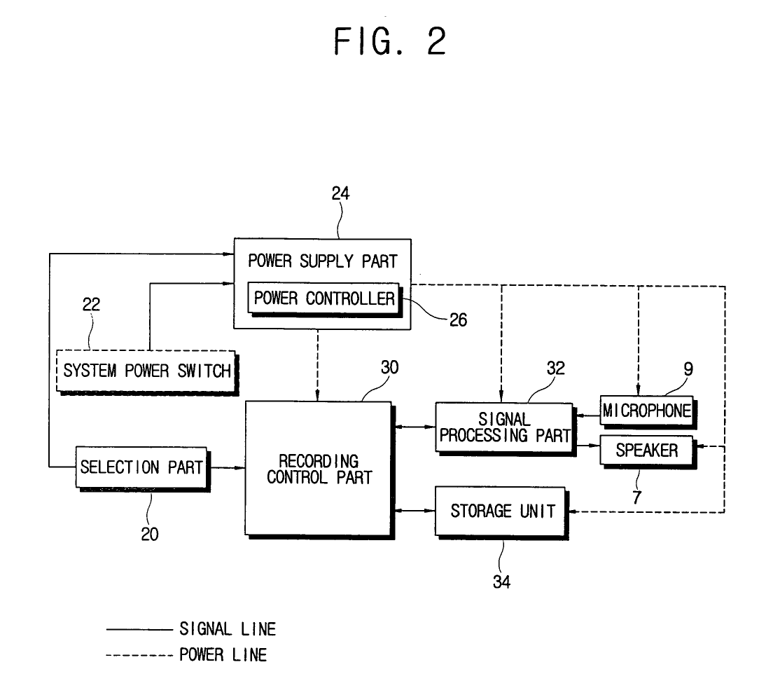

FIG. 2 is a functional control block diagram of the computer system of FIG. 1, according to an embodiment of the present invention. The portable computer system 1 comprises a power supply part 24; the microphone 9 and the speaker 7 for an input and an output of the voice signal respectively; the selection part 20 for the user's choice of voice recording (as will be described in more detail further below); a signal handling (processing) part 32 handling the voice signals; a storage unit 34 for saving (storing) data; and a recording control part 30 controlling a recording process according to the selection part 20.

A computer system generally comprises a CPU, a memory, and a system device part for inputs and outputs. The memory herein can be (without limitation) RAM, BIOS ROM, CMOS RAM, and so forth. The BIOS ROM has a BIOS (Basic Input Output System) which is a type of embedded software controlling and testing the system devices. Under control of a power controller 26, the power supply part 24 supplies power(s), as shown in FIG. 2, to all (normally required) or various (selected) components attached on (provided on or in communication with) the main board. Typically, in a normal booting mode, the power is supplied by the power supply part 24 to the normally required system components according to PS_ON (power supply on) signals from a PS_ON circuit in the main board when a system power switch 22 is turned on (activated).

Typically, a chip initiating a computer system reset generates a signal to reset whole circuits, including the CPU, when the power is applied to the system in the normal booting mode by the power supply part 24. After reset, the CPU runs the BIOS stored in the BIOS ROM to perform a POST (Power On Self Test) process, and as the case may be, the CPU loads an O/S (Operating System), for example, MICROSOFT WINDOWS, allowing the user to work on the computer system based on the operating system.

The signal handling part 32 comprises a codec (coder/decoder), a converter, and so on, and handles (processes) input data through the microphone 9 under control of the recording control part 30, or manages the voice data stored in the system and outputs the handled data through the speaker 7. Typically, the storage unit 34 is a hard disk to store numerous (large amount of) voice data including many other data.

The selection part 20, according to which the user can select a sound recording function, can be implemented by a button, as shown in FIG. 1. According to an aspect of the invention, the selection part 20 may be implemented in software. For example, a keyboard hot key may be used for the sound recording function selection. Upon activation of the selection part 20 when power is not being provided by the power supply part 24 to the computer system 1, a sound recording selection signal from the selection part 20 is provided to the power supply part 24, and to the recording control part 30.

When power is not being supplied to the computer system 1, such that the computer system 1 is turned off, the power controller 26 controls the power supply part 24 to supply powers to sound recording components, in response to the sound recording selection signal from the selection part 20. Typically, the sound recording components comprise the CPU, the microphone 9, the speaker 7, the signal handling part 32, the storage unit 34, and the recording control part 30, in response to the sound recording selection signal from the selection part 20. Therefore, if power is not being supplied to the computer system 1 and the selection part 20 is activated, the power can be supplied to only the sound recording components without turning on the system power switch 22 (i.e., without turning on the computer system 1) as shown in FIG. 2, thereby placing the computer system 1 in a computer sound recording only mode (i.e., a non-booting computer sound recording mode.

In the case that the computer power is turned off and the selection part 20 is activated, the selection part 20 also sets up a scan code that generates an interrupt signal for the CPU (not shown) to call the recording control part 30 (to be described later), in response to the sound recording selection signal. More particularly, in the case the selection part 20 is selected and the computer system 1 is turned off, an interrupt generating part (not shown) generates the scan code to output the interrupt signal to the CPU to call the recording control part 30.

Upon receipt of the interrupt signal from the selection part 20, the CPU stops an on-going process and controls the recording control part 30 to perform its function. By selecting the voice recording via the selection part 20, the recording control part 30 processes voice (sound) signals input through the microphone 9 via the signal handling part 32 and stores the processed sound data in the storage unit 34. If the user selects sound replaying via, for example, a user interface presented by the computer system 1 (as will be described in more detail below), or another selection part (not shown), the voice recording control part 30 reads the voice data stored in the storage unit 34, provides the read data to the signal handling part 32 for processing, and outputs the processed voice data through the speaker 7.

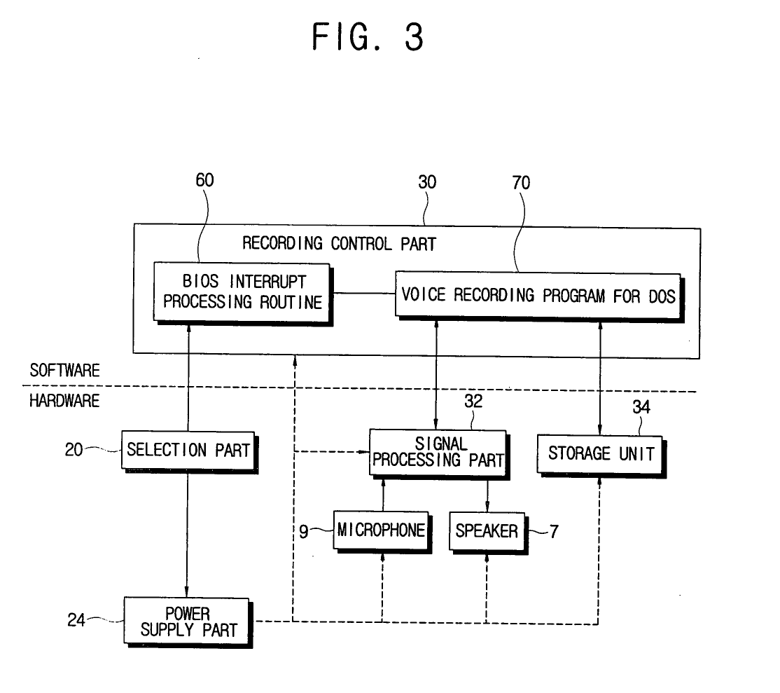

FIG. 3 is a functional control block diagram of voice recording before booting up in the computer system of FIG. 2. Typically, the recording control part 30 is implemented in software including an interrupt processing routine 60 and a voice (sound) recording program 70. Typically, the selection part 30, signal processing part 32, including the microphone 6 and the speaker 7, the storage unit 34, and the microphone, are implemented in hardware, including computing hardware. The interrupt processing routine 60 is called by the CPU responding to the interrupt signals generated by the selection part 20, and the interrupt processing routine 60 calls the voice recording program 70. Thus, the voice recording program records voice signals input through the microphone 9. More particularly, typically, the voice recording program 70 is available for recording, playing, repeat play, volume and speed control, section repeat play, and so on, by interfacing with the hardware implemented signal processing part 32 and the storage unit 34. As shown in FIG. 2 and FIG. 3, the power supply part 24 supplies powers to the microphone 9, the speaker 7, the signal processing part 32, the storage unit 34, and the BIOS ROM (not shown) to operate their functions, if the selection part 20 selects voice recording when the system power switch 22 is turned off (i.e., the computer system 1 is turned off).

According to an aspect of the invention, the recording control part 30 comprises a BIOS interrupt processing circuit 60 and a voice recording program for DOS (Disk Operating System) 70. However, the present invention is not limited to a DOS operation system voice recording program, and a sound recording program compatible with any other operating system can be used. The BIOS interrupt processing routine 60 is disposed in the BIOS ROM, and called by the CPU responding to the interrupt signals from the selection part 20. The BIOS interrupt processing routine 60 called by the CPU calls the voice recording program for DOS 70 stored in the storage unit 34. However, according to an aspect of the invention, the voice recording program for DOS 70 can be saved in the BIOS ROM. Thus, as shown in FIGS. 2 and 3, without having the computer system 1 powered normally (i.e., without booting the computer system 1), the voice recording program for DOS 70 simply records voice (sound), if the selection part 20 has been activated to select voice recording.

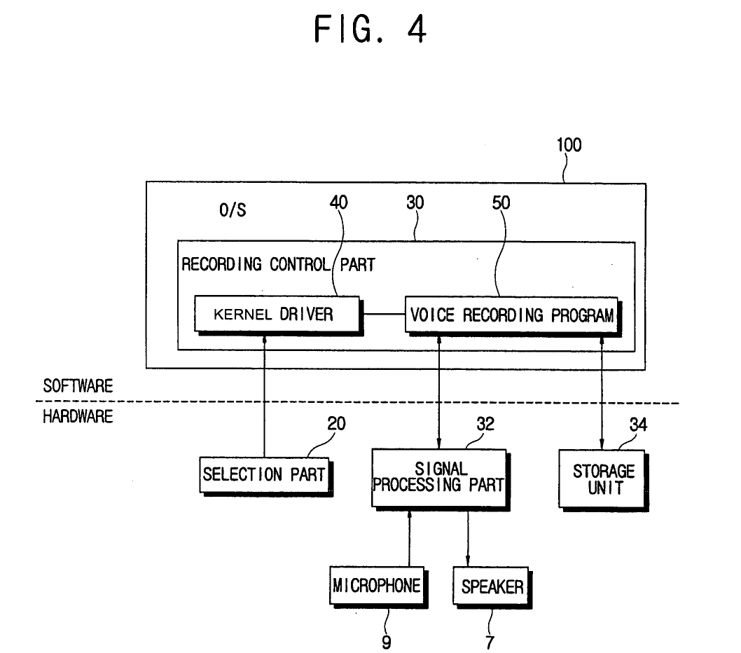

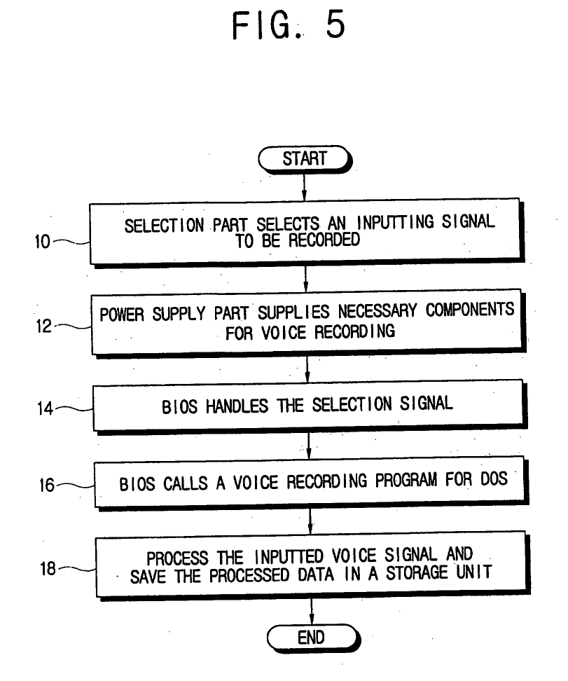

FIG. 4 is a functional control block diagram of voice recording after booting up in the computer system of FIG. 2. As shown in FIG. 4, the recording control part 30 comprises a kernel driver 40 and a RAM-resident voice recording program 50 when voice recording is selected via the selection part 20 after the computer system 1 boots up under the control of an operation system 100. While the system is booting up, the interrupt processing routine 60 is replaced with the kernel driver 40 through an API (Application Programming Interface). The kernel driver 40 is called by the CPU responding to the interrupt signals selectively generated by the selection part 20 after the system boots up. The kernel driver 40 called by the CPU calls the RAM-resident voice recording program 50 by referencing a registry, thereby the voice recording program 50 can perform voice recording after computer system boots up under control of the operation system 100. The RAM-resident voice recording program 50 is compatible with any type of operating system 100, such as MICROSOFT WINDOWS.

FIG. 5 is a flowchart of the voice recording before the computer system boot up, according to FIG. 3. At operation 10, the user selects voice (sound) recording via the selection part 20. Then, at operation 12, the power supply part 24 supplies powers to the necessary components for voice recording, in response to the selection part 20 selecting voice recording. At operation 14, responding to the selection part 20, the BIOS interrupt processing routine 60 is called by the CPU and processes the interrupt. At operation 16, the interrupt processing routine 60 calls the voice (sound) recording program for DOS 70. Then, at operation 18, the voice recording program for DOS 70 executes to control the signal handling part 32 to process signals input through the microphone 9, and to store the processed voice (sound) data in the storage unit 34.

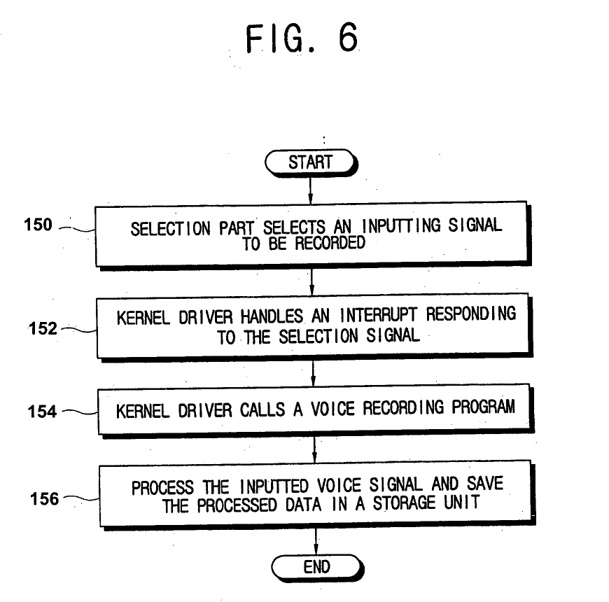

FIG. 6 is a flowchart of the voice recording after the computer system boot up, according to FIG. 4. At operation 150, the user selects voice (sound) recording via the selection part 20. Then, at operation 152, the kernel driver 40 is called by the CPU to process an interrupt, in response to the selection part 20. At operation 154, the kernel driver 40 calls the voice recording program 50, which executes with an operation system 100, such the MICROSOFT WINDOWS. Then, at operation 156, the voice recording program 50 is executes to control (or interface with) the signal handling part 32 processing the input sound signals through the microphone 9. At operation 156, typically, the input voice data is saved as a file format in a file structured data storage area of the storage unit 34.

More particularly, in a case the system has not been booted up, the voice recording program 50 transfers the voice data saved in the predetermined area of storage unit 34 to the file storage of the storage unit 34 using a sound recording program suitable for an embedded environment execution, such as (without limitation) the sound recording program 70 for the DOS operating system, as opposed to the sound recording program 50 suitable for an application level execution, which typically provides a user display interface.

According to an aspect of the invention, the selection part 20 including an interrupt generating part, according to the present invention, can also be disposed in the display panel 5, a mouse, or any other hardware manipulation device in communication with the computer system 1. Further, according to the above-described embodiment of the invention, power is only applied to the sound recording components and the voice recording program for DOS 70 is used for sound recording, when the selection part 20 selects sound recording without power being supplied to the system 1. However, the present invention is not limited to such a configuration, and the voice recording program for DOS 70 can be run while the system 1 is booting up with power supplied to the whole system 1.

According to the above-described embodiment of the invention, the recording control part 30 is implemented by software including the interrupt processing routine 60 and the voice recording programs 70, 50, and can be a MICOM programmed to perform voice (sound) recording, controlling the signal handling part 32, and the storage unit 34, as the selection part 20 selects sound recording. The present invention performs a voice (sound) recording, when a user selects voice recording without powers being supplied to a whole system by manipulating a voice recording selection part to activate a power supply part to supply power only to voice recording components of the system and to activate a recording control part controlling voice recording. Accordingly, the present invention provides a computer system providing sound signal recording functions regardless of whether the system boots up.

More particularly, the present invention provides a method comprising controlling a powered off computer to record sound signals, in response to a sound recording selection via a hardware sound recording selector. Further, the present invention provides a computer, comprising a hardware sound recording selector; a power supply; a hardware sound recording component receiving power from the power supply upon a sound recording selection from the hardware sound recording selector; and a programmed computer processor receiving the power from the power supply upon the sound recording selection from the hardware sound recording selector and controlling the powered sound recording component to record sound signals, if the computer is powered off. Typically, the hardware sound recording component comprises a control processor, a microphone, a signal processor, and a data storage. Further, the programmed computer processor controls the powered sound recording component to record the sound signals in response to the sound recording selection from the hardware sound recording selector, if the computer is powered on. The computer can further comprise a software sound recording selector, and the programmed computer processor controls the powered sound recording component to record sound signals in response to a sound recording selection from the software sound recording selector, if the computer is powered on. Further, the present invention provides a portable (laptop) computer, comprising a hardware sound recording selector, and a programmed computer processor allowing sound recording regardless of whether the system boots up in response to an input by (i.e., a user input via) the sound recording selector.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer system having a microphone inputting a sound signal and a storage unit storing data, comprising:
a selection part outputting a sound recording selection signal;
a signal processing part processing the sound signal input through the microphone;
a recording control part managing the input sound signal to be processed by the signal processing part, in response to the sound recording selection signal from the selection part and storing the processed sound data in the storage unit; and
a power supply part supplying power only to sound recording system components including the microphone, the storage unit, the signal processing part, and the recording control part, when the selection part outputs the sound recording selection signal and power is not supplied to the computer system.

2. The computer system according to claim 1, further comprising an interrupt generating part generating an interrupt signal, in response to the sound recording selection signal of the selection part; and
wherein the recording control part comprises:
an interrupt processing routine processing the interrupt signal from the interrupt generating part, and
a sound recording program called by the interrupt processing routine.

3. The computer system according to claim 2, further comprising a BIOS ROM storing the interrupt processing routine, and wherein the sound recording program is disposed either in the BIOS ROM or the storage unit.

4. The computer system according to claim 2, further comprising a BIOS ROM storing the interrupt processing routine, and wherein
the interrupt processing routine calls the sound recording program to be executed, in response to the sound recording selection signal of the selection part when the power is not supplied to the computer system.

5. The computer system according to claim 4, wherein the sound recording program executes under control of disc operating system (DOS).

6. The computer system according to claim 2, wherein the recording control part comprises:
a pre-determined driver based on an operating system, and
a random access memory (RAM) resident sound recording program called by the driver in response to the sound recording selection signal of the selection part after the computer system boots up.

7. The computer system according to claim 6, wherein the driver interfaces with the RAM-resident sound recording program via an application programming interface.

8. The computer system according to claim 6, wherein the RAM-resident sound recording program presents a user interface to select replaying the stored sound data in the storage unit, and the RAM-resident sound recording program reads the stored sound data from the storage unit, if replay is selected through the user interface, and controls the signal processing part to process the read sound data and output the processed sound data through a speaker.

9. A method of controlling a computer system having a microphone inputting a sound signal and a storage unit storing data, comprising,
selecting sound recording;
processing the input sound signal through the microphone according to the sound recording selecting and storing the processed sound data in the storage unit; and
supplying power to sound recording system components including the microphone and the storage unit, when sound recording is selected and power is not supplied to the computer system.

10. The control method of the computer system according to claim 9, further comprising;
generating an interrupt signal, in response to the sound recording selecting; and
calling a sound recording program according to the interrupt signal.

11. The control method of the computer system according to claim 10, wherein the calling of the sound recording program according to the interrupt signal is by a BIOS program, and the method further comprises storing the sound recording program in either a BIOS ROM or the storage unit.

12. The control method of the computer system according to claim 9, further comprising:
calling a driver based on an operating system, in response to the sound recording selecting; and
calling a random access memory (RAM) resident sound recording program by the driver.

13. The control method of the computer system according to claim 11, wherein disc operating system (DOS) controls the sound recording program.

14. The control method of the computer system according to claim 10, further comprising:
calling a pre-determined driver based on an operating system according to the interrupt signal; and
calling a random access memory (RAM) resident sound recording program by the driver, in response to the sound recording selecting after the computer system boots up.

15. The control method of the computer system according to claim 14, wherein the call of the RAM-resident sound recording program comprises interfacing the driver and the sound recording program via an application programming interface.

16. The control method of the computer system according to claim 9, further comprising,
selecting replay of the sound data stored in the storage unit;
reading the stored sound data from the storage unit to be signal processed; and
outputting the processed sound data through a speaker, in respond to the replay selecting.

17. A computer, comprising:
a hardware sound recording selector;
a power supply;
a hardware sound recording component receiving power from the power supply upon a sound recording selection from the hardware sound recording selector; and
a programmed computer processor receiving the power from the power supply upon the sound recording selection from the hardware sound recording selector and controlling the powered sound recording component to record sound signals, if the computer is powered off.

18. The computer of claim 17, wherein the hardware sound recording component comprises a microphone, a signal processor, and a data storage.

19. The computer of claim 17, wherein the programmed computer processor controls the powered sound recording component to record the sound signals in response to the sound recording selection from the hardware sound recording selector, if the computer is powered on.

20. The computer of claim 17, further comprising a software sound recording selector, and wherein the programmed computer processor controls the powered sound recording component to record sound signals in response to a sound recording selection from the software sound recording selector, if the computer is powered on.
